(19) United States
(12) Patent Application Publication
(10) Pub. No.: US 2005/0196087 A1
(43) Pub. Date: Sep. 8, 2005

(54) Ball bearing and self-winding timepiece

(76) Inventors: Morinobu Endo, Suzuka-shi (JP); Tetsuo Uchiyama, Tokyo (JP); Akio Yamaguchi, Nagoya-shi (JP); Yasuo Kondo, Nagoya-shi (JP); Hiroshi Aoyama, Nagoya-shi (JP); Koichiro Jujo, Kisarazu-shi (JP); Kazutoshi Takeda, Sakura-shi (JP); Masato Takenaka, Misato-shi (JP); Shigeo Suzuki, Ichikawa-shi (JP); Takeshi Tokoro, Tokyo (JP)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/063,914

(22) Filed: Feb. 23, 2005

Related U.S. Application Data
(63) Continuation of application No. PCT/JP03/10947, filed on Aug. 28, 2003.

(30) Foreign Application Priority Data
Aug. 29, 2002 (JP) P 2002-250550

(51) Int. Cl. F16C 33/44; F16C 29/04

(52) U.S. Cl. 384/527

(57) ABSTRACT

The present invention relates to a ball bearing that includes a plurality of balls and a retainer. The present invention also relates to a self-winding timepiece that is provided with a ball bearing. The present invention employs a retainer that is formed from a resin that contains filler as a component element of the ball bearing. Alternatively, the present invention employs a ball bearing that has a retainer that is formed from a resin that contains filler as a component element of the self-winding timepiece.

### CROSS-REFERENCE TO RELATED APPLICATION

This application is a continuation and claims priority to International Application No. PCT/JP03/10947 filed Aug. 28, 2003, and the entire content of the application is hereby incorporated by reference.

### BACKGROUND OF THE INVENTION

1. Field of the Invention

The present invention relates to a ball bearing that includes an outer ring, an inner ring, a plurality of balls, and a retainer. The present invention also relates to a self-winding timepiece that is provided with a rotating spindle and a ball bearing.

2. Description of Related Art

The structure of a conventional self-winding timepiece is disclosed in, for example, Japanese Patent Application Laid-Open (JP-A) No. 11-183645. In this self-winding timepiece, the movement is provided with a self-winding mechanism that includes a ball bearing, a rotating spindle that is fixed to the ball bearing, and a rotation weight that is fixed to the rotating spindle. Here, the term “movement” refers to a portion of a mechanical body of a timepiece that includes a drive portion. In the movement, the terms “glass side”, “character plate side”, and “rear side” refer to the side where the glass is located, namely, the side where the character plate is located relative to the bottom plate when the movement is assembled in the case. In contrast, in the movement, “front side” and “rear cover side” refer to the side where the back cover is located relative to the bottom plate when the movement is assembled in the case. A front ring train that includes a barrel wheel, a second wheel, a third wheel, a fourth wheel and the like, a square hole wheel, a first wheel bridge and second wheel bridge, an escapement mechanism, a speed adjustment mechanism, a self-winding mechanism and the like are located on the “front side”, namely, on the “rear cover side” of the bottom plate. The rear ring train, the calendar mechanism, and the like are located on the “rear side” of the bottom plate.

In a self-winding mechanism, if the rotating spindle is rotated, then rotating spindle teeth that are provided integrally with the rotating spindle are rotated. A first transmission wheel is then rotated by the rotation of the rotating spindle teeth. A pawl lever is then moved reciprocally by the rotation of the first transmission wheel based on the eccentric movement of an eccentric shaft portion of the first transmission wheel. A second transmission gear is provided with a ratchet gear. The pawl lever is provided with a push pawl and a draw pawl. The push pawl and draw pawl mesh with the ratchet gear of the second transmission wheel. The second transmission wheel is rotated in a fixed direction by the reciprocal movement of the push pawl and draw pawl. The square hole wheel is rotated by the rotation of the second transmission wheel, and a spiral spring inside the barrel wheel is wound up.

As is shown in FIGS. 6 to 8, in the movement of a self-winding timepiece, a ball bearing portion of the rotating spindle, namely, a ball bearing 962 is provided with an inner ring 968, a holding ring 970, and an outer side ring, namely, an outer ring 972. The holding ring 970 is fixed to the inner ring 968. Accordingly, the inner ring 968 and the holding ring 970 constitute an inner side ring. Five balls 974 are inserted between an inclined surface portion of the inner ring 968, namely, a first inner side guide portion together with an inclined surface portion of the holding ring 970, namely, a second inner side guide portion, and two inclined surface portions of the outer ring 972, namely, an outer side guide portion. Rotating spindle teeth 972b are provided on an outer circumferential portion of the outer ring 972. A retainer 976 is inserted between the inner ring 968 and the holding ring 970 in order for the plurality of balls 974 to be positioned with a space between each. A metal plate formed from stainless steel or the like is used for the retainer 976, and the outer configuration of this metal plate is formed by press-working the metal plate. Five ball positioning portions 976g that are formed in a semi-circular shape are provided in the retainer 976 in order to position the balls 974. Lubricant oil is injected into the areas surrounding the respective balls 974.

The ball bearings used in a movement in a conventional self-winding timepiece have a structure that includes an outer ring, an inner ring (that includes a holding ring that is fixed to the inner ring), a plurality of balls, and a retainer. States of contact (i.e., of sliding) between these components can be divided into “rolling contact” and “sliding contact”. Namely, the contact between the outer ring and the balls is a “rolling contact”. The contact between the inner ring (and the holding ring) and the balls is a “rolling contact”. The contact between the retainer and the balls is a “sliding contact”. If a comparison is made between “rolling contact” and “sliding contact”, then it is generally known that “sliding contact” has poorer wear resistance than “rolling contact”. Accordingly, in a conventional ball bearing, the lifespan of the ball bearing has often been determined by how far retainer wear has advanced. If lubricant oil is injected onto the balls in order to reduce this type of wear on the retainer, the following problems occur.

Firstly, there is a possibility that the lubricant oil will be scattered by vibration or shock when the ball bearing is being used. The result of this is that the possibility arises that lubricant oil will become adhered to areas that do not require it, thereby causing a deterioration in the performance of a variety of components. For example, if lubricant oil adheres to the surfaces of gear teeth, there is a possibility of increased viscosity loss in the ring train mechanism. Moreover, if lubricant oil adheres to the hair spring, there is a possibility that the accuracy of the timepiece will become abnormal.

Secondly, the viscosity of the lubricant oil is changed by changes in temperature. As a result, there is a possibility that this will cause a deterioration in various characteristics. For example, in a low temperature state, the viscosity of the lubricant oil increases and the startup torque increases, so that there is a possibility that the response will deteriorate. Moreover, in a high temperature state, the viscosity of the lubricant oil is lowered, so that there is a possibility that the allowable load will be decreased and oil flow will be generated.

Thirdly, there is a possibility that, due to oxidation of the lubricant oil and evaporation of the lubricant oil, the quantity of the injected lubricant oil will decrease so that the lubrication performance will deteriorate. As a result of this, there is a possibility that wear of the components will increase, or alternatively, that abrasion powder will be generated and spread, thereby causing a deterioration in the performance of the timepiece.

Fourthly, there is a possibility that, due to wear of the retainer, abrasion powder will be present in the lubricant oil, thereby causing the viscosity of the lubricant oil to increase, and causing the startup torque to increase, and also causing the response to deteriorate.

Fifthly, because the surface area where the portions such as the balls that receive an oil injection can be seen from outside the ball bearing is considerable, and there is a large amount of evaporation of lubricant oil, there is a possibility that rust will be generated on nearby components by the volatile constituents thereof, and that other chemical reactions will be induced. Moreover, because dust and the like from the outside is more easily able to penetrate into the ball bearing such as onto the ball guide surfaces and the like, there is a possibility that, as a result of this, the life span of the ball bearing will be shortened.

### SUMMARY OF THE INVENTION

The ball bearing of the present invention is constructed so as to include: an outer side ring; an inner side ring; a plurality of balls; and a retainer that positions the plurality of balls, wherein the outer side ring has an outer side guide portion that guides the plurality of balls, and the inner side ring has an inner side guide portion that guides the plurality of balls, and the plurality of balls are placed between the outer side guide portion and the inner side guide portion. In the ball bearing of the present invention, the retainer is formed from a filler impregnated resin that is obtained by taking a thermoplastic resin as a base resin, and adding carbon filler to this base resin.

In the ball bearing of the present invention, because it is possible to reduce the wear on the retainer even if a lubricant is not injected onto the balls, the performance of the ball bearing can be maintained over an extended period of time. Furthermore, the bearing characteristics such as dynamic torque and response are not easily affected by the temperature environment in which it is used. Moreover, in the ball bearing of the present invention, when lubricant oil is injected onto the balls, a structure can be achieved that is able to withstand heavier loads. Accordingly, when the ball bearing of the present invention is used in a self-winding timepiece, the lifespan of the self-winding timepiece can be lengthened. Furthermore, the ball bearing of the present invention can be widely used as a bearing in timepieces and measuring instruments; photographic, sound recording and image recording instruments; printing instruments; production, processing and assembling machinery; and transporting, conveyance and dispensing machinery and the like.

In the ball bearing of the present invention, it is preferable if the base resin is selected from a group that includes polystyrene, polyethylene terephthalate, polycarbonate, polyacetal (polyoxymethylene), polyamide, modified polyphenylene ether, polybutylene terephthalate, polyphenylene sulfide, polyether ether ketone, and polyetherimide.

In the ball bearing of the present invention, it is also preferable if the carbon filler is selected from a group made up of mixtures obtained by doping any one of a monolayer carbon nanotube, a multilayer carbon nanotube, a vapor grown carbon fiber, a nanografiber, a carbon nanophone, a cupstack type of carbon nanotube, a monolayer fullerene, a multilayer fullerene, and the aforementioned carbon filler with boron.

In the ball bearing of the present invention, it is also preferable if the inner side ring includes an inner ring and an inner holding ring, and if the inner side guide portions are formed in the inner and the inner holding ring. Alternatively, in the ball bearing of the present invention, it is also preferable if the outer side ring includes an outer ring and an outer holding ring, and if the outer side guide portions are formed in the outer ring and the outer holding ring. By employing a structure such as this, the inner side ring and outer side ring can be easily formed, and a plurality of balls can be easily inserted between the inner side ring and the outer side ring. Moreover, by employing this structure, the plurality of balls can be positioned apart from each other using the retainer.

Furthermore, in the ball bearing of the present invention, it is preferable if the retainer is formed in a circular cylinder shape, and guide holes or guide window portions that guide the plurality of balls are formed spaced apart from each other in the retainer. By employing this structure, the plurality of balls can be positioned apart from each other using the retainer.

Furthermore, in the ball bearing of the present invention, it is possible for an inward flange portion that extends inwardly in a radial direction to be formed on the retainer, and for an inner side portion of the inward flange portion to be placed between the inner ring and the inner holding ring. By employing this structure, the retainer can be reliably supported between the inner ring and the inner holding ring.

Furthermore, in the ball bearing of the present invention, it is possible for an outward flange portion that extends outwardly in a radial direction to be formed on the retainer, and for an outer side portion of the outward flange portion to be placed between the outer ring and the outer holding ring. By employing this structure, the retainer can be reliably supported between the outer ring and the outer holding ring.

Furthermore, in the ball bearing of the present invention, it is possible for retainer to be constructed so as to include an upper retainer portion that is formed in a circular cylinder shape and a lower retainer portion that is formed in a circular cylinder shape, and for the upper retainer portion and the lower retainer portion to be constructed so as to be able to be attached to and separated from each other, and for guide window portions that guide the plurality of balls spaced apart from each other to be formed in the upper retainer portion and the lower retainer portion. By employing this structure, the plurality of balls can be placed between the inner side guide portion and the outer side guide portion, and the upper retainer portion and the lower retainer portion can be incorporated after that.

Furthermore, the present invention is a self-winding timepiece that includes: a rotating spindle that includes a rotation; a ball bearing having the above described structure that rotatably supports the rotating spindle; and a self-winding mechanism that is operated by a rotation of the rotating spindle in order to wind up a spiral spring. By employing this structure the lifespan of the self-winding timepiece can be lengthened.

### BRIEF DESCRIPTION OF THE DRAWINGS

FIG. 1 is a plan view showing a schematic configuration, as seen from the front side of the movement when the self-winding mechanism has been removed, of the first embodiment of the self-winding timepiece of the present invention (in FIG. 1, a portion of the components have been omitted);

FIG. 2 is a plan view showing a schematic configuration of the self-winding mechanism of the first embodiment of the self-winding timepiece of the present invention (in FIG. 1, a portion of the components have been omitted);

FIG. 3 is a partial cross-sectional view showing a front ring train mechanism of the first embodiment of the self-winding timepiece of the present invention;

FIG. 4 is a partial cross-sectional view showing a portion of an escapement mechanism in the first embodiment of the self-winding timepiece of the present invention;

FIG. 5 is a partial cross-sectional view showing a self-winding mechanism in the first embodiment of the self-winding timepiece of the present invention;

FIG. 6 is a perspective view showing a partial cross-section of a ball bearing of a conventional self-winding timepiece;

FIG. 7 is a perspective view showing a partial cross-section of a ball bearing of a conventional self-winding timepiece;

FIG. 8 is a perspective view showing a retainer and balls of a conventional self-winding timepiece;

FIG. 9 is a perspective view showing a partial cross-section of a ball bearing in the first embodiment of the self-winding timepiece of the present invention;

FIG. 10 is a perspective view showing a partial cross-section of a ball bearing in the first embodiment of the self-winding timepiece of the present invention;

FIG. 11 is a perspective view showing a retainer and balls in the first embodiment of the self-winding timepiece of the present invention;

FIG. 12 is a perspective view showing a partial cross-section of a ball bearing in the second embodiment of the self-winding timepiece of the present invention;

FIG. 13 is a perspective view showing a partial cross-section of a ball bearing in the second embodiment of the self-winding timepiece of the present invention;

FIG. 14 is a perspective view showing a retainer and balls in the second embodiment of the self-winding timepiece of the present invention;

FIG. 15 is a perspective view showing a partial cross-section of a ball bearing in the third embodiment of the self-winding timepiece of the present invention;

FIG. 16 is a perspective view showing a partial cross-section of a ball bearing in the third embodiment of the self-winding timepiece of the present invention;

FIG. 17 is a perspective view showing a retainer and balls in the third embodiment of the self-winding timepiece of the present invention;

FIG. 18 is a perspective view showing a partial cross-section of a ball bearing in the fourth embodiment of the self-winding timepiece of the present invention;

FIG. 19 is a perspective view showing a partial cross-section of a ball bearing in the fifth embodiment of the self-winding timepiece of the present invention; and

FIG. 20 is a perspective view showing a partial cross-section of a ball bearing in the fifth embodiment of the self-winding timepiece of the present invention.

### DETAILED DESCRIPTION OF THE INVENTION

A description will now be given of embodiments of the self-winding timepiece and ball bearing of the present invention based on the drawings.

### (1) Structure of the First Embodiment

The structure of the first embodiment of the self-winding timepiece of the present invention (including the ball bearing of the present invention) will now be described.

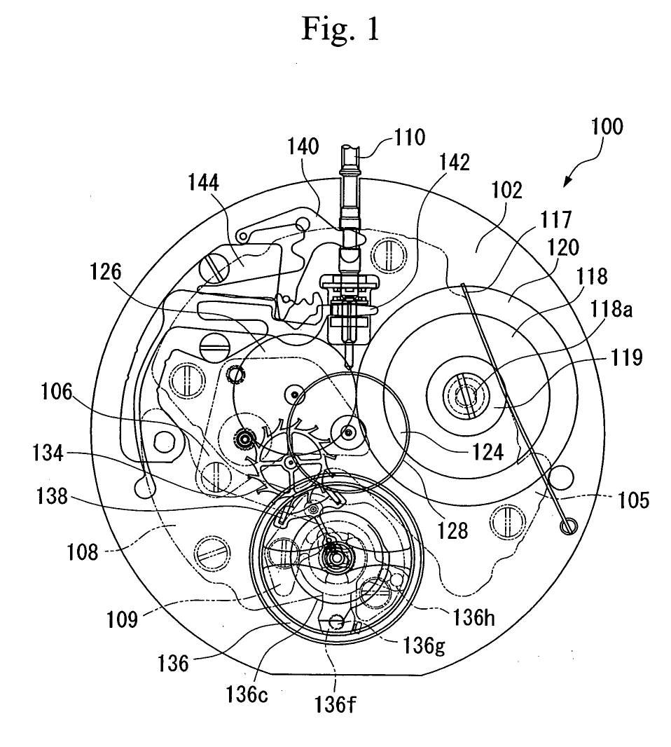

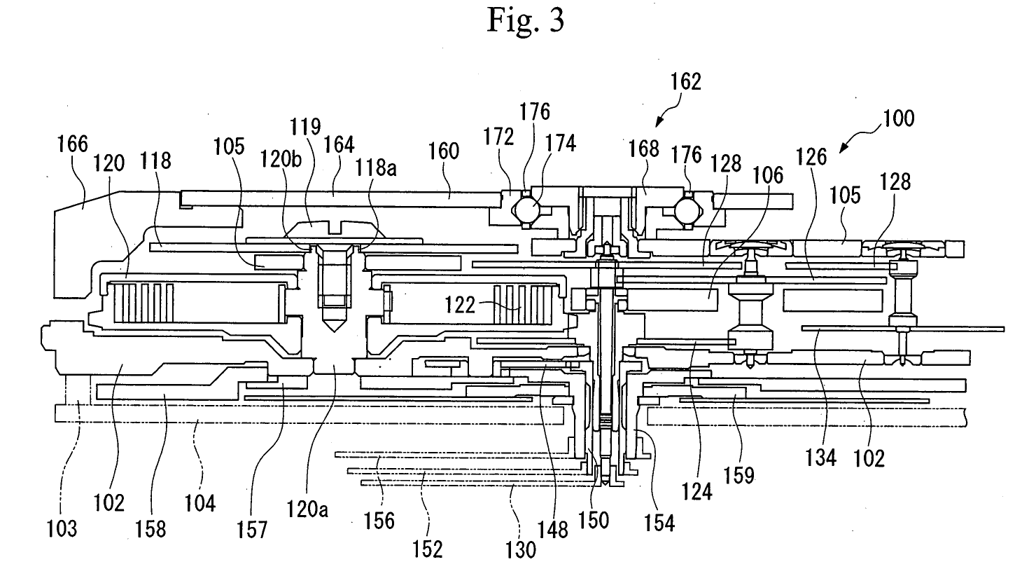

Referring to FIG. 1 through FIG. 5, in the self-winding timepiece of the present invention, a movement 100 of the self-winding timepiece is provided with a bottom plate 102, a first bridge 105, a second bridge 106, and adjustment bridge 108, and an anchor escapement 109. The first bridge 105, the second bridge 106, and the adjustment bridge 108 are incorporated in the rear cover side of the bottom plate 102. The second bridge 106 is placed between the first bridge 105 and the bottom plate 102. A winding stem 110 is incorporated in the bottom plate 102. A character plate 104 (shown by the chain double-dashed lines in FIGS. 3 to 5) is attached to the bottom plate 102 via a character plate bridge ring 103.

A structure is employed in which the position in the axial direction of the winding stem 110 is determined by a switching device that includes a set lever 140, a locking lever 142, and a clutch 144. A square hole wheel 118 is incorporated on the rear cover side of the first bridge 105. A square hole 118a of the square hole wheel 118 is included in a square portion 120b of a barrel stem 120a of a barrel wheel 120. A square hole screw 119 fixes the square hole wheel 118 to the barrel stem 120a. A plate-shaped clasp 117 that is used to regulate the rotation of the square hole wheel 118 is provided so as to match teeth portions of the square hole wheel 118. A spiral spring 122 is housed in the barrel wheel 120.

A structure is employed in which, as a result of the square hole wheel 118 being rotated, the spiral spring 122 that is housed in the barrel wheel 120 is wound up. In this structure, a second wheel 124 is rotated by the rotation of the barrel wheel 120. An escapement wheel 134 is rotated via the rotation of a fourth wheel 128, a third wheel 126, and the second wheel 124. The barrel wheel 120, the second wheel 124, the third wheel 126, and the fourth wheel 128 form a front ring train. The barrel wheel 120, the escapement wheel 134, and the third wheel 126 are assembled so as to be able to be rotated relative to the first bridge 105 and the bottom plate 102. The second wheel 124 is assembled so as to be able to be rotated relative to the second bridge 106 and the bottom plate 102. The fourth wheel 128 is assembled so as to be able to be rotated relative to the first bridge 105 and the second bridge 106.

An escapement/speed adjustment device that is used to control the rotation of the front ring train includes an adjuster 136, the escapement wheel 134, and the anchor 138. The anchor 138 is assembled so as to be able to be rotated relative to the anchor bridge 109 and the bottom plate 102. The adjuster 136 is assembled so as to be able to be rotated relative to the adjustment bridge 108 and the bottom plate 102. The adjuster 136 includes an adjustment stem 136a, an adjustment ring 136b, and a hair spring 136c. A structure is employed in which a cylindrical gear 150 is rotated simultaneously based on a rotation of the second wheel 124. A minute needle 152 that is attached to the cylindrical gear 150 displays minutes. A slip mechanism for the second wheel 124 is provided on the cylindrical gear 150. The second wheel 124 is rotated once per hour by the rotation of the barrel wheel 120. Based on the rotation of the cylindrical gear 150, a cylindrical wheel 154 is rotated once every 12 hours via the rotation of a day rear wheel 148. An hour needle 156 that is attached to the cylindrical wheel 154 displays hours.

The hair spring 136c is a thin plate spring having a vortex (i.e., spiral) configuration that is wound a plurality of times. An inner end portion of the hair spring 136c is fixed to a hair ball 136d that is fixed to the adjustment stem 136a. An outer end portion of the hair spring 136c is fixed by thread fastening via a hair holder 136g that is attached to a hair holder bridge 136f that is fixed to the adjustment bridge 108. A tempo needle 136h is rotatably attached to the adjustment bridge 108. A hair bridge 136j and a hair rod 136k are attached to the tempo needle 136h. Portions near the outer end portion of the hair spring 136c are positioned between the hair bridge 136j and the hair rod 136k.

The fourth wheel 128 is rotated once per minute by the rotation of the second wheel 124 via the rotation of the third wheel 126. A second needle 130 is attached to the fourth wheel 128.

A date wheel holder 157 is incorporated on the glass side of the bottom plate 102. The character plate 104 is included on the glass side of the date wheel holder 157. A date wheel 158 is rotatably supported by the bottom plate 102 and the date wheel holder 157. A day wheel 159 is placed between the character plate 104 and the date wheel holder 157. The day wheel 159 is able to be rotated relative to the cylindrical gear 154. A date wheel 158 is constructed so as to be rotated by the rotation of the cylindrical wheel 154 via a date forwarding mechanism (not shown). The day wheel 159 is constructed so as to be rotated by the rotation of the cylindrical wheel 154 via a day forwarding mechanism (not shown).

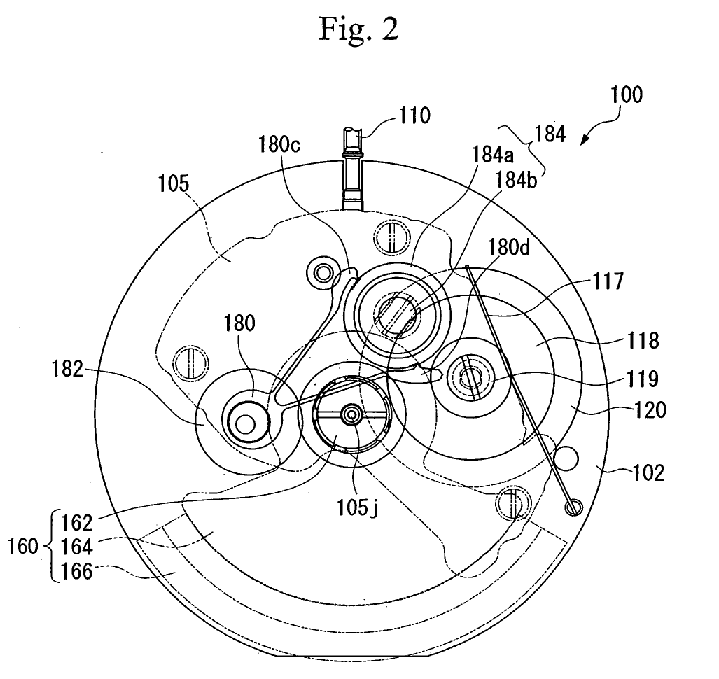

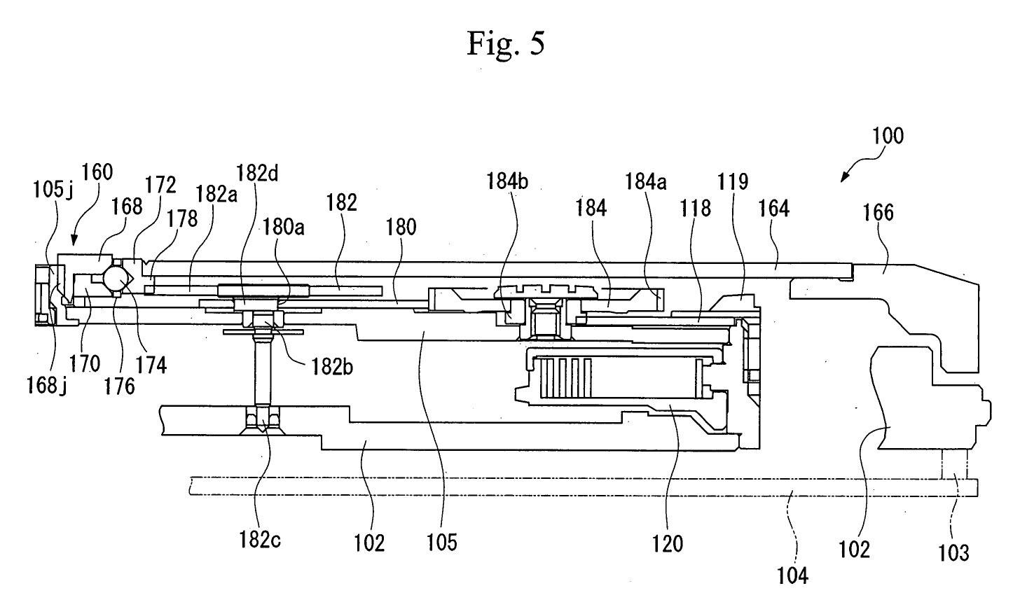

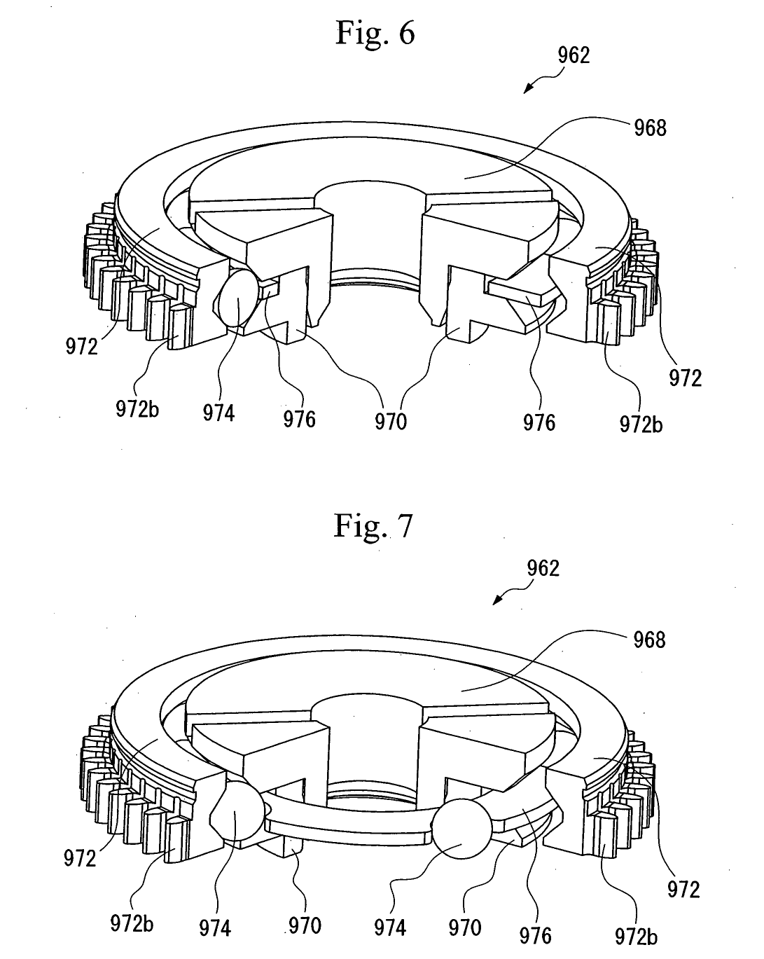

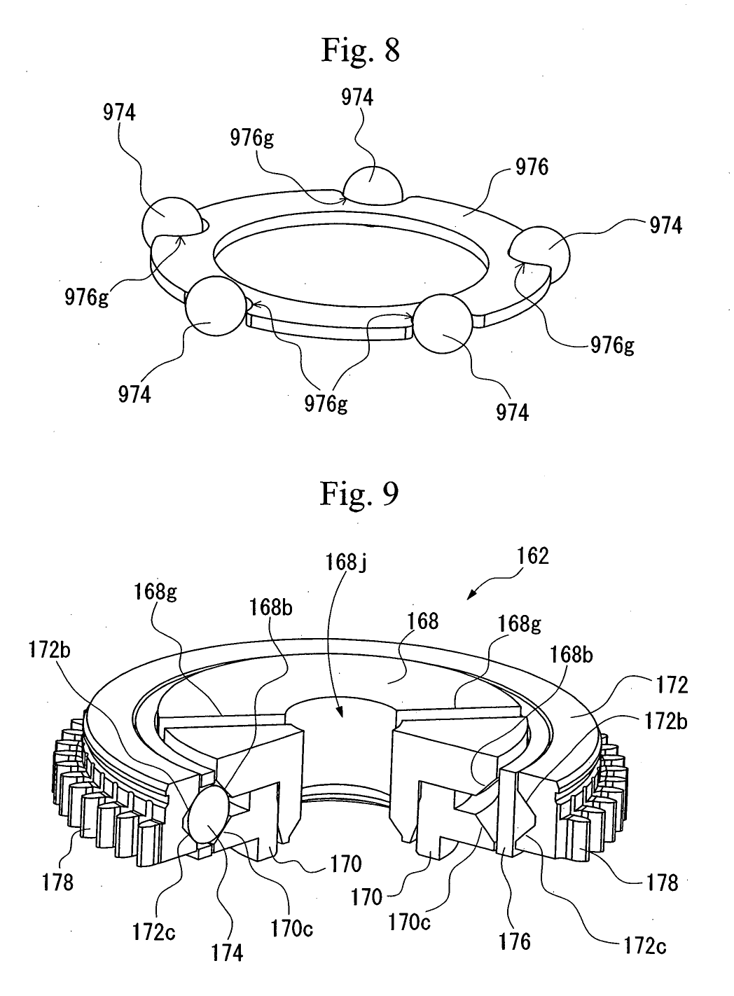

Referring to FIG. 2 and FIG. 5, a rotating spindle 160 includes a ball bearing 162, a rotating spindle body 164, and a rotation weight 166. The ball bearing 162 includes an inner ring 168, an inner holding ring 170, an outer ring 172, and a plurality of balls 174. Rotating spindle teeth 178 are provided on the outer ring 172. An inner ring female thread 168j is provided in a center hole in the inner ring 168. A ball bearing fixing screw 105j is provided on the first bridge 105. A center axis of the ball bearing fixing screw 105j is formed so as to be identical with a center axis of the fourth wheel 128 (i.e., with a center axis of the second wheel 124 and a center axis of the cylindrical wheel 154). By fastening the inner ring female thread 168j to the ball bearing fixing screw 105j, the ball bearing 162 is fixed to the first bridge 105.

A first transmission wheel 182 is incorporated so as to be able to be rotated relative to the first bridge 105 and the bottom plate 102. The first transmission wheel 182 has a first transmission gear 182a, an upper guide shaft portion 182b, a lower guide shaft portion 182c, and an eccentric shaft portion 182d. The first transmission gear 182a is positioned between the rotating spindle body 164 and the first bridge 105. The first transmission gear 182a is formed so as to mesh with the rotation spindle teeth 178. The eccentric shaft portion 182d is provided on the first transmission wheel 182 between the first transmission gear 182a and the upper guide shaft portion 182b. A center axis of the eccentric shaft portion 182d is formed so as to be offset from the center axis of the first transmission gear 182a. The upper guide shaft portion 182b is supported so as to be rotatable around the first bridge 105. The lower guide shaft portion 182c is supported so as to be rotatable around the bottom plate 102.

A pawl lever 180 is incorporated between the first transmission gear 182a and the first bridge 105. A portion of the pawl lever 180 is positioned between the first transmission gear 182a and the first bridge 105. Remaining portions of the pawl lever 180 are positioned between the rotating spindle body 164 and the first bridge 105. The pawl lever 180 has a draw pawl 180c and a push pawl 180d. A guide hole 180a of the pawl lever 180 is rotatably incorporated in the eccentric shaft portion 182d. The second transmission wheel 184 is supported so as to be rotatable around the first bridge 105. The second transmission wheel 184 has a second transmission gear 184a and second transmission teeth 184b. The second transmission gear 184a is formed in the shape of a ratchet gear. The second transmission gear 184a is positioned between the rotating spindle body 164 and the first bridge 105.

The draw pawl 180c and the push pawl 180d of the pawl lever 180 engage with the second transmission gear 184a. The second transmission teeth 184b mesh with the square hole wheel 118. The draw pawl 180c and the push pawl 180d are urged by elastic force towards the center of the second transmission gear 184a, and the draw pawl 180c and the push pawl 180d are prevented from moving away from the second transmission gear 184a.

When the rotating spindle 160 rotates, the rotating spindle teeth 178 also rotate at the same time. The first transmission wheel 182 is rotated by the rotation of the rotating spindle teeth 178. The pawl lever 180 performs a reciprocal movement based on an eccentric movement of the eccentric shaft portion 182d as a result of the rotation of the first transmission wheel 182. The second transmission wheel 184 is made to rotate in a constant direction by the draw pawl 180c and the push pawl 180d. The square hole wheel 118 is rotated by the rotation of the second transmission wheel 184, and the spiral spring 122 inside the barrel wheel 120 is wound up.

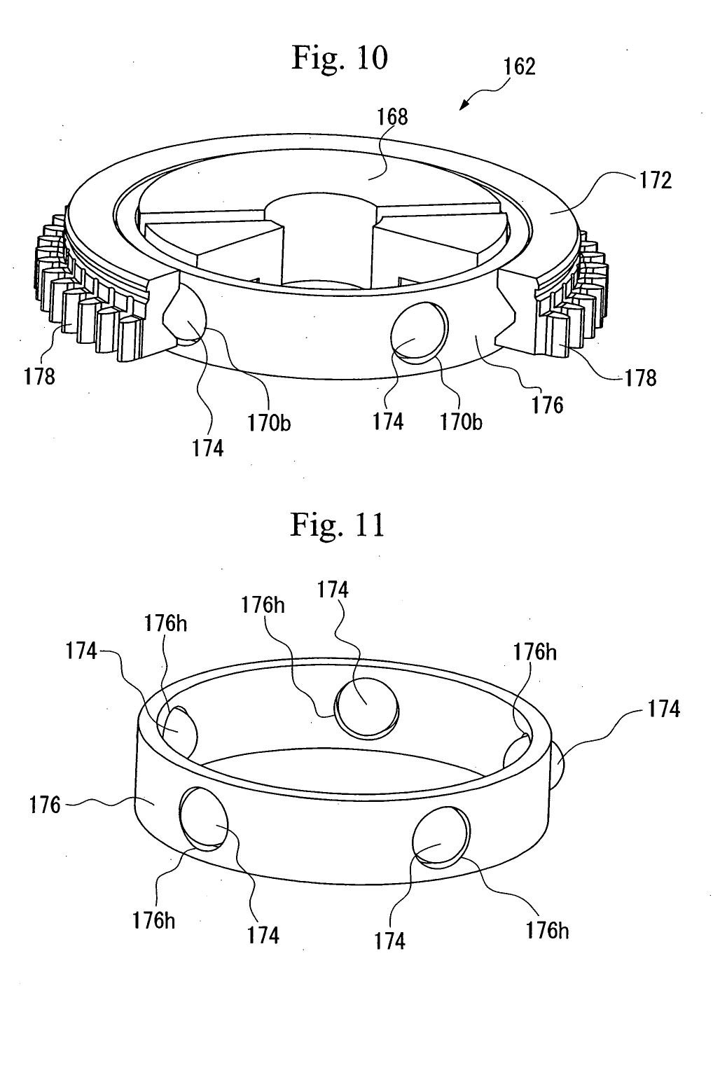

Referring to FIG. 9 to FIG. 11, the ball bearing 162 includes an inner ring 168, an inner holding ring 170, an outer ring 172, and a plurality of balls 174. For example, five balls 174 are placed between the inner ring 168 and inner holding ring 170 and the outer ring 172. The inner holding ring 170 is fixed to the inner ring 168. The inner ring 168 and the inner holding ring 170 form an inner side ring. An inner ring female thread 168j is provided in a center hole in the inner ring 168. An inner ring screwdriver slot 168g is provided in a top side of the inner ring 168. The outer ring 172 forms an outer side ring. Rotation spindle teeth 178 are provided in the outer ring 172. The inner ring 168 has a first inner side guide portion 168b for guiding the plurality of balls 174. The inner holding ring 170 has a second side inner guide portion 170c for guiding the plurality of balls 174. The outer ring 172 has a first outer side guide portion 172b and a second outer side guide portion 172c for guiding the plurality of balls 174. The five balls 174 are arranged with a space between each between the first inner side guide portion 168b and second inner side guide portion 170c and the first outer side guide portion 172b and second outer side guide portion 172c.

It is preferable that, if a cut is made along a plane that includes the center axis of the rotating spindle 160, the first inner side guide portion 168b is formed as a conical surface that forms an angle of 45° relative to the top surface of the inner ring 168. It is also preferable that, if a cut is made along a plane that includes the center axis of the rotating spindle 160, the second inner side guide portion 170c is formed as a conical surface that forms an angle of 45° relative to the bottom surface of the inner ring 168. It is also preferable that, if a cut is made along a plane that includes the center axis of the rotating spindle 160, the first inner side guide portion 168b is formed so as to form an angle of 90° relative to the second inner side guide portion 170c. It is also preferable that, if a cut is made along a plane that includes the center axis of the rotating spindle 160, the first outer side guide portion 172b is formed as a conical surface that forms an angle of 45° relative to the top surface of the outer ring 172. It is also preferable that, if a cut is made along a plane that includes the center axis of the rotating spindle 160, the second outer side guide portion 172c is formed as a conical surface that forms an angle of 45° relative to the bottom surface of the outer ring 172. It is also preferable that, if a cut is made along a plane that includes the center axis of the rotating spindle 160, the first outer side guide portion 172b is formed so as to form an angle of 90° relative to the second outer side guide portion 172c. It is also preferable that, if a cut is made along a plane that includes the center axis of the rotating spindle 160, the first outer side guide portion 172b is formed so as to form an angle of 90° relative to the first inner side guide portion 168bc. It is also preferable that, if a cut is made along a plane that includes the center axis of the rotating spindle 160, the second outer side guide portion 172c is formed so as to form an angle of 90° relative to the second inner side guide portion 170c.

A retainer 176 is formed in a cylindrical shape. The retainer 176 is provided with five guide holes 176h that are spaced apart from each other (preferably equidistantly) and respectively guide the five balls 174. The shape of the guide holes may be circular, as is shown in the drawings, or may be polygonal. As a variant example, it is also possible to form guide window portions that are spaced apart from each other (preferably equidistantly) for guiding the five balls 174 in the retainer 176. The shape of the guide window portions may be circular or may be a U shape, a C shape, a Ω shape, or a polygonal shape.

In the embodiment shown in FIG. 9 to FIG. 11, a description is given of five balls 174, however, in the ball bearing of the present invention the number of balls 174 maybe three, four, five, or six or more. More preferably, it is desirable that the number of balls is an odd number such as three, five, seven, nine, eleven, or the like. By using a plurality of balls 174, the outer ring 172 can be rotated smoothly relative to the inner ring 168 and the inner holding ring 170.

In the ball bearing of the present invention, a structure can be employed in which lubricant oil is not injected around the balls 174. Moreover, in the ball bearing of the present invention, it is also possible for lubricant oil to be injected around the balls 174. If a structure is employed in which lubricant oil is not injected around the balls 174, it is possible to do away with the possibility that lubricant oil will be scattered by vibration or impact when the ball bearing is being used. It is also possible to do away with the possibility that the viscosity of the lubricant oil will be changed by a change in the temperature thereof, thereby resulting in a deterioration in a variety of characteristics. If a structure is employed in which lubricant oil is injected around the balls 174, then because it is possible to reduce the surface area where the portions of the balls that receive-injected oil can be seen from outside the ball bearing, the evaporation amount of the lubricant oil can be reduced, and it is possible to decrease the possibility that rust will be generated on adjacent components by volatile components in the lubricant oil, or that other chemical reactions will be induced. Moreover, because it is possible to make it difficult for dust or the like from outside to enter into the ball bearing such as onto a ball guide surface or the like, the possibility of dust becoming contained in the lubricant oil and consequently shortening the lifespan of the ball bearing can be reduced.

The retainer 176 can be formed by taking a thermoplastic resin as a base resin and then supplying a carbon filler to this base resin so as to form a filler impregnated resin. For example, the retainer 176 may be formed by the injection molding of a filler impregnated resin that is obtained by taking a thermoplastic resin as a base resin and then supplying a carbon filler to this base resin. Accordingly, in a self-winding timepiece that contains the ball bearing of the present invention, maintenance is simplified due to the durability of the retainer 176.

Generally, the base resin used in the present invention is polystyrene, polyethylene terephthalate, polycarbonate, polyacetal (polyoxymethylene), polyamide, modified polyphenylene ether, polybutylene terephthalate, polyphenylene sulfide, polyether ether ketone, or polyetherimide. Namely, in the present invention the base resin may be what is known as a general purpose engineering plastic, or may be what is known as a super engineering plastic. Note that, in the present invention, general purpose engineering plastics or super engineering plastics other than those mentioned above can be used for the base resin. It is preferable that the base resin used in the present invention is a thermoplastic resin.

The carbon filler used in the present invention is obtained by doping any one of a monolayer carbon nanotube, a multilayer carbon nanotube, a vapor grown carbon fiber, a nanografiber, a carbon nanophone, a cupstack type of carbon nanotube, a monolayer fullerene, a multilayer fullerene, and the aforementioned carbon filler with boron.

It is preferable that the carbon filler is added to the resin in a ratio of 0.2 to 60 percent by weight of the total weight of the filler containing resin. Alternatively, it is preferable that the carbon filler is added to the resin in a ratio of 0.1 to 30 percent by volume of the total volume of the filler impregnated resin.

It is preferable that the monolayer carbon nanotube has a diameter of 0.4 to 2 nm, and an aspect ratio (i.e., length/diameter) of 10 to 1000, with an aspect ratio of 50 to 100 being particularly preferable. The monolayer carbon nanotube is formed as a hexagon mesh having a cylindrical configuration or conical configuration, and has a monolayer structure. The monolayer carbon nanotube can be obtained from Carbon Nanotechnologies Inc. (CNI) of the United States as “SWNT”.

It is preferable that the multilayer carbon nanotube has a diameter of 2 to 100 nm, and an aspect ratio of 10 to 1000, with an aspect ratio of 50 to 100 being particularly preferable. The multilayer carbon nanotube is formed as a hexagon mesh having a cylindrical configuration or conical configuration, and has a multilayer structure. The multilayer carbon nanotube can be obtained from Nikki Denso Co. as “MWNT”.

These types of carbon nanotubes are described in “Carbon Nanotubes—Rapidly Developing Electronic Applications” in “Nikkei Science” March, 2001, Items 52 to 62, and also in “The Challenge of Nano Materials” in “Nikkei Mechanical” December, 2001, Items 36 to 57 by P. G Collins et. al. The structure of resin composite materials that contain carbon fiber and a process for manufacturing these are disclosed, for example, in JP-A No. 2001-200096.

It is preferable that the vapor grown carbon fiber has a diameter of 50 to 200 nm, and an aspect ratio of 10 to 1000, with an aspect ratio of 50 to 100 being particularly preferable. The vapor grown carbon fiber is formed as a hexagon mesh having a cylindrical configuration or conical configuration, and has a multilayer structure. The vapor grown carbon fiber can be obtained from Showa Denko K.K. as “VGCF”. The vapor grown carbon fiber is disclosed, for example, in JP-A Nos. 5-321039, 7-150419, and 3-61788.

It is preferable that the nanografiber has an outer diameter of 2 to 500 nm, and an aspect ratio of 10 to 1000, with an aspect ratio of 50 to 100 being particularly preferable. The nanografiber has a substantially solid cylindrical configuration. The nanografiber can be obtained from Noritake Isei Denshi K.K.

It is preferable that the carbon nanophone has an outer diameter of 2 to 500 nm, and an aspect ratio of 10 to 1000, with an aspect ratio of 50 to 100 being particularly preferable. The carbon nanophone is formed as a hexagonal mesh in a cup shape.

The cupstack type of carbon nanotube has a configuration in which the carbon nanophones are stacked in a cup shape, and preferably has an aspect ratio of 10 to 1000, with an aspect ratio of 50 to 100 being particularly preferable.

Fullerene is a molecule that has a carbon cluster as the nucleus thereof, and, by CAS definition, is a molecule having a closed sphere configuration in which 20 or more carbon atoms combine with the three atoms adjacent thereto. A monolayer fullerene has the shape of a soccer ball. It is preferable that the diameter of the monolayer fullerene is 0.1 to 500 nm. It is also preferable that the composition of the monolayer fullerene is C60 to C540. The monolayer fullerene is, for example, C60, C70, or C120. The diameter of the C60 is approximately 0.7 nm. Multilayer fullerene has a nested shape obtained by concentrically stacking the aforementioned monolayer fullerenes. It is preferable that the multilayer fullerene has a diameter of 0.1 to 1000 nm, with a diameter of 1 to 500 being particularly preferable. It is also preferable that the composition of the multilayer fullerene is C60 to C540. It is preferable that the multilayer fullerene has a structure in which, for example, C70 is placed on an outer side of C60, and C120 is then further placed outside this C70. This type of multilayer fullerene is described, for example, in “Multilayer Generation of Onion Structure Fullerenes and Their Application as Lubrication Materials” by Takahiro Kakiuchi et. al. in “Precision Engineering Bulletin”, Vol. 67, No. 7, 2001, Pp. 1175-1179.

Furthermore, the carbon filler can be manufactured by doping one of the aforementioned carbon fillers (i.e., the monolayer carbon nanotube, the multilayer carbon nanotube, the vapor grown carbon fiber, the nanografiber, the carbon nanophone, the cupstack type of carbon nanotube, the monolayer fullerene, and the multilayer fullerene) with boron. A method of doping the carbon filler with boron is described, for example, in JP-A No. 2001-2000096. In the method described in JP-A No. 2001-2000096, boron and carbon fiber that has been manufactured using a vapor phase method are mixed using a Henschel mixer type of mixer, and the resulting mixture undergoes heat processing at approximately 2300° C. in a high frequency furnace or the like. The heat processed mixture is then crushed in a crusher. Next, the base resin and the crushed mixture are combined in a predetermined ratio, and are melted and kneaded in an extruder so that pellets are manufactured.

In the embodiment of the present invention that is described above, the base resin is generally polystyrene, polyethylene terephthalate, polycarbonate, polyacetal(polyoxymethylene), polyamide, modified polyphenylene ether, polybutylene terephthalate, polyphenylene sulfide, polyether ether ketone, or polyetherimide, however, it is also possible to use other plastics, for example, thermoplastic resins such as polysulfone, polyethersulfone, polyethylene, nylon 6, nylon 66, nylon 12, polypropylene, ABS resin, and AS resin and the like as the base resin. It is also possible to use a mixture of two or more of the above thermoplastic resins as the base resin. Furthermore, it is also possible to combine additives (e.g., antioxidants, lubricants, plasticizers, stabilizers, fillers, and solvents) with the base resin that is used in the present invention.

### (2) Structure of the Second Embodiment

Next, the structure of the second embodiment of the self-winding timepiece of the present invention will be described. The description below is mainly concerned with points of variance between the second embodiment and first embodiment of the self-winding timepiece of the present invention. Accordingly, parts that are not described below correspond here to the description of the first embodiment of the self-winding timepiece of the present invention given above. The movement of the second embodiment of the self-winding timepiece of the present invention includes a ball bearing 262.

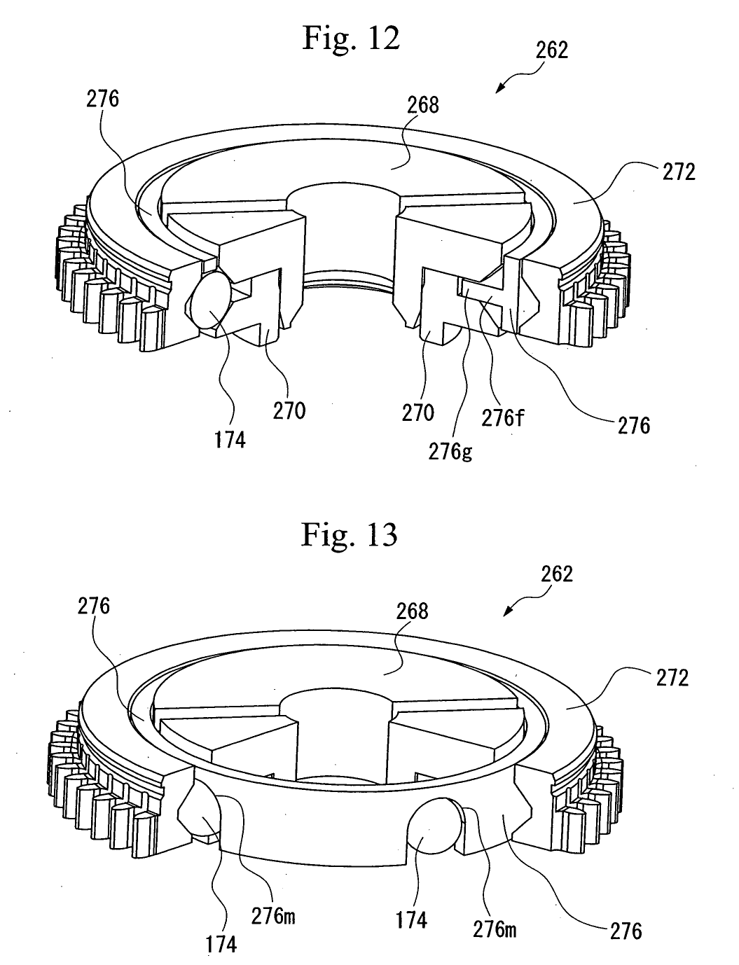

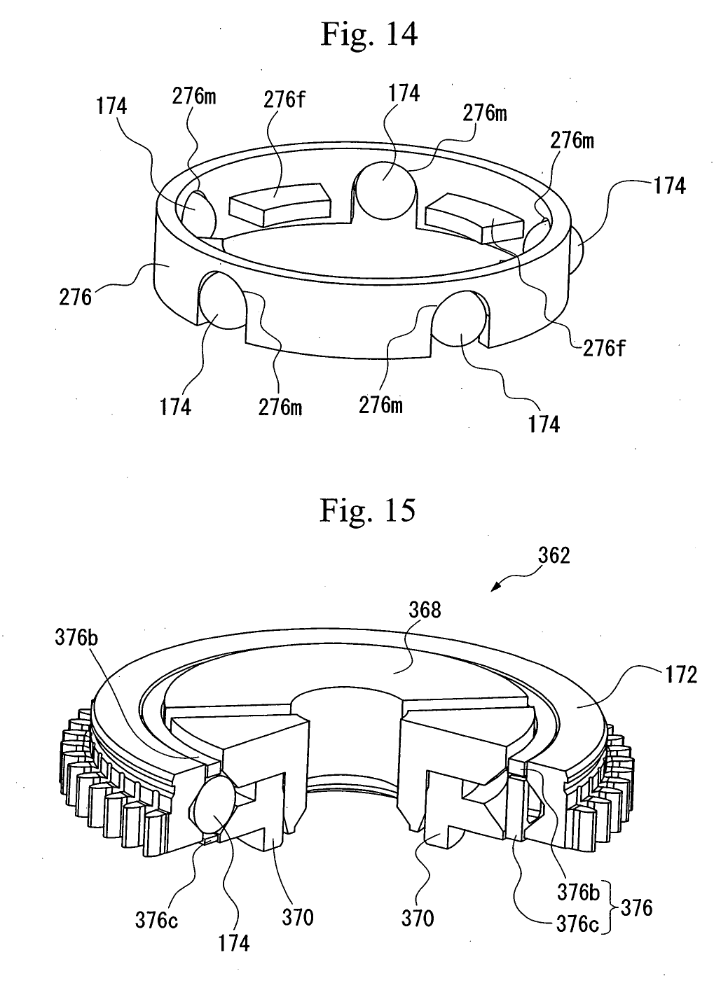

Referring to FIG. 12 to FIG. 14, the ball bearing 262 includes an inner ring 268, an inner holding ring 270, an outer ring 272, and five balls 174. A retainer 276 is provided with five guide window portions 276m that are placed apart from each other (preferably equidistantly) and guide each of the five balls 174. The guide window portions 276m contain a portion that is formed in a semicircular shape for guiding the balls 174. Inward flange portions 276f that extend inwards in the radial direction are formed on the retainer 276. Five inward flange portions 276f are formed between the respective guide window portions 276m. Inner side portions 276g of the inward flange portions 276f are placed between the inner ring 268 and the holding ring 270. As a result of this structure, the retainer 276 can be reliably held between the inner ring 268 and the holding ring 270. Accordingly, in a state in which the holding ring 270, the five balls 176, and the outer ring 272 are set, because it is possible to insert the retainer 276 and then finally fix the inner ring 268 to the holding ring 270, the ease of assembly is excellent. Furthermore, because less lubricated surface is exposed to the outside of the ball bearing than in a conventional example, it is possible to reduce the evaporation amount of lubricant and to decrease the amount of dust that enters the ball bearing.

### (3) Structure of the Third Embodiment

Next, the structure of the third embodiment of the self-winding timepiece of the present invention will be described. The description below is mainly concerned with points of variance between the third embodiment and first embodiment of the self-winding timepiece of the present invention. Accordingly, parts that are not described below correspond here to the description of the first embodiment of the self-winding timepiece of the present invention given above. The movement of the third embodiment of the self-winding timepiece of the present invention includes a ball bearing 362.

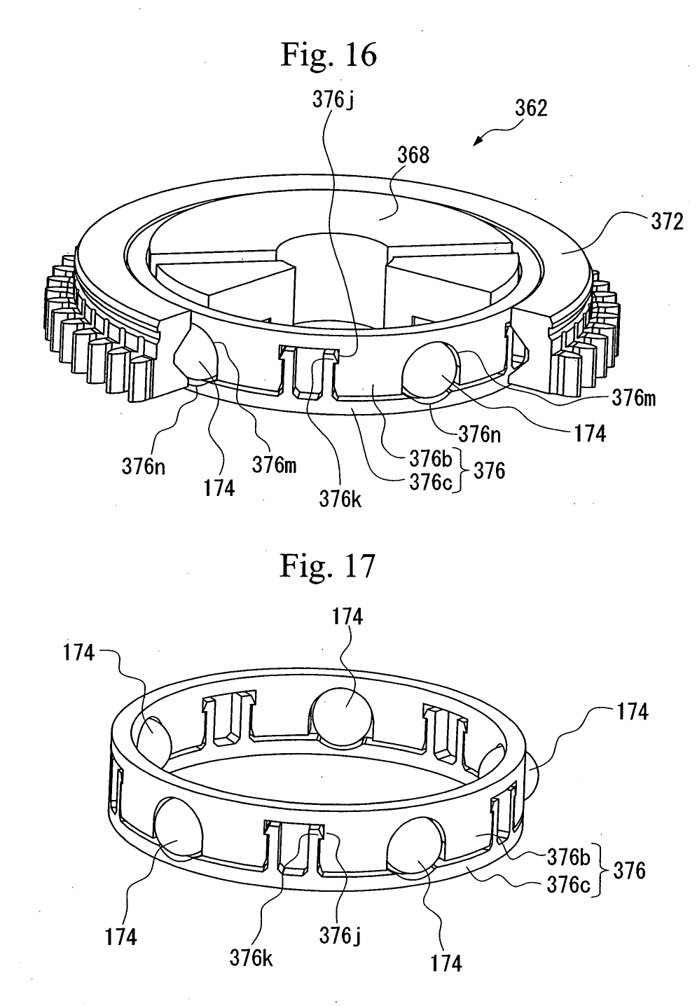

Referring to FIG. 15 to FIG. 17, the ball bearing 362 includes an inner ring 368, an inner holding ring 370, an outer ring 372, and five balls 174. A retainer 376 includes an upper retainer portion 376b that is formed in a cylindrical shape, and a lower retainer portion 376c that is formed in a cylindrical shape. The upper retainer portion 376b and the lower retainer portion 376c are formed such that they are able to be removed and attached. The upper retainer portion 376b is provided with five sets of receiving notches 376j. The lower retainer portion 376c is provided with five sets of locking protrusions 376k. By engaging the locking protrusions 376k with the receiving notches 376j, the upper retainer portion 376b and the lower retainer portion 376c can be fixed to each other so as to form a single body.

Upper guide window portions 376m that guide the five balls 174 at a distance (preferably equidistantly) from each other are formed in the upper retainer portion 376b. The upper guide window portions 376m include portions that are formed in a U shape. Lower guide window portions 376n that guide the five balls 174 at a distance (preferably equidistantly) from each other are formed in the lower retainer portion 376c. The lower guide window portions 376n contain portions that are formed in a crescent shape.

### (4) Structure of the Fourth Embodiment

Next, the structure of the fourth embodiment of the self-winding timepiece of the present invention will be described. The description below is mainly concerned with points of variance between the fourth embodiment and first embodiment of the self-winding timepiece of the present invention. Accordingly, parts that are not described below correspond here to the description of the first embodiment of the self-winding timepiece of the present invention given above. The movement of the fourth embodiment of the self-winding timepiece of the present invention includes a ball bearing 462.

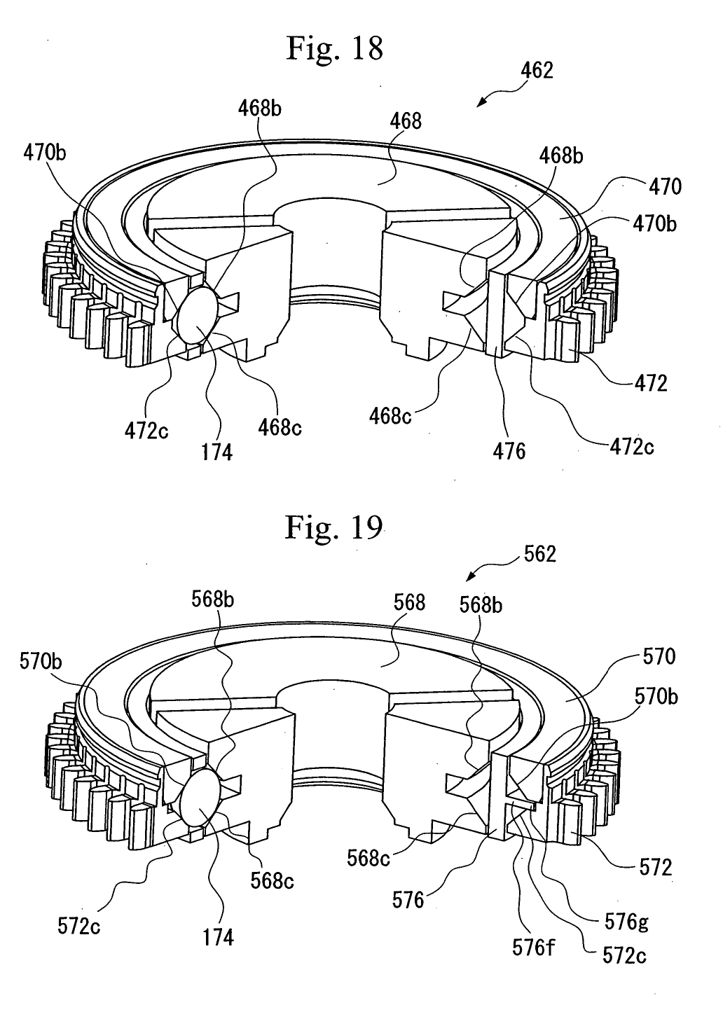

Referring to FIG. 18, the ball bearing 462 includes an inner ring 468, an outer holding ring 470, an outer ring 472, and five balls 174. The outside holding ring 470 is fixed to the outer ring 472. The inner ring 468 forms an inner side ring. The outer holding ring 470 and the outer ring 472 form an outer side ring. The inner ring 468 has a first inner side guide portion 468b and a second inner side guide portion 468c that guide the plurality of balls 174. The outside holding ring 470 has a first outer side guide portion 470b that guides the plurality of balls 174. The outer ring 472 has a second outer side guide portion 472c that guides the plurality of balls 174. The five balls 174 are placed spaced apart from each other between the first inner side guide portion 468b and second inner side guide portion 468c and the first outer side guide portion 470b and second outer side guide portion 472c.

### (5) Structure of the Fifth Embodiment

Next, the structure of the fifth embodiment of the self-winding timepiece of the present invention will be described. The description below is mainly concerned with points of variance between the fifth embodiment and first embodiment of the self-winding timepiece of the present invention. Accordingly, parts that are not described below correspond here to the description of the first embodiment of the self-winding timepiece of the present invention given above. The movement of the fifth embodiment of the self-winding timepiece of the present invention includes a ball bearing 562.

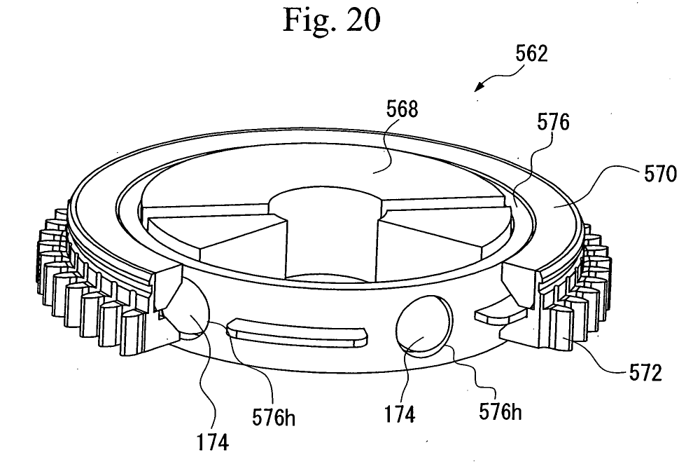

Referring to FIG. 19 and FIG. 20, the ball bearing 562 includes an inner ring 568, an outer holding ring 570, an outer ring 572, and five balls 174. The outside holding ring 570 is fixed to the outer ring 572. The inner ring 568 forms an inner side ring. The outer holding ring 570 and the outer ring 572 form an outer side ring. The inner ring 568 has a first inner side guide portion 568b and a second inner side guide portion 5 and 68c that guide the plurality of balls 174. The outside holding ring 570 has a first outer side guide portion 570b that guides the plurality of balls 174. The outer ring 572 has a second outer side guide portion 572c that guides the plurality of balls 174. The five balls 174 are placed spaced apart from each other between the first inner side guide portion 568b and second inner side guide portion 568c and the first outer side guide portion 570b and second outer side guide portion 572c.

A retainer 576 is provided with five guide holes 576h that are spaced apart from each other (preferably equidistantly) and respectively guide the five balls 174. The guide holes 576h may be formed in a circular shape in order to guide the balls 174. Outward flange portions 576f that extend outwards in the radial direction are formed on the retainer 576. Five outward flange portions 576f are formed between the respective guide window portions 576m. Outer side portions 576g of the outward flange portions 576f are placed between the outer holding ring 570 and the outer ring 572. As a result of this structure, the retainer 576 can be reliably held between the outer holding ring 570 and the outer ring 572. Accordingly, in a state in which the outer ring 572, the five balls 176, and the inner ring 568 are set, because it is possible to insert the retainer 576 and then finally fix the outer holding ring 570 to the outer ring 572, the ease of assembly is excellent. Furthermore, because less lubricated surface is exposed to the outside of the ball bearing than in a conventional example, it is possible to reduce the evaporation amount of lubricant and to decrease the amount of dust that enters the ball bearing.

### (6) Operation of the Self-Winding Timepiece of the Present Invention

Next, the operation of the self-winding timepiece of the present invention will be described.

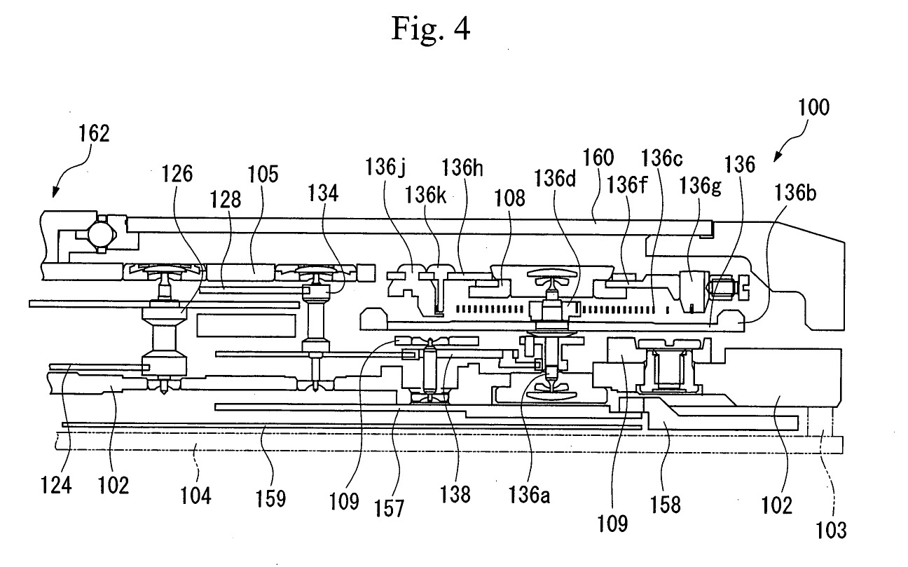

Referring to FIG. 4, if the rotating spindle 160 is rotated in a first direction, namely, in a clockwise direction in FIG. 2, the first transmission wheel 182 is rotated in an anticlockwise direction in FIG. 2 by the rotation of the rotating spindle teeth 178.

In the pawl lever 180, the eccentric shaft portion 182d makes an eccentric movement due to the rotation of the first transmission wheel 182. As a result of the eccentric movement of the pawl lever 180, the draw pawl 180c and the push pawl 180d each make a reciprocal movement along an outer circumferential portion of the second transmission wheel 184. As a result of this, due to the reciprocal movement of the draw pawl 180c and the push pawl 180d, the second transmission wheel 184 is rotated in a constant direction, namely, in an anticlockwise direction in FIG. 2. As a result of the rotation in an anticlockwise direction of the second transmission gear 184, the square hole wheel 118 is rotated in a constant direction, namely, in a clockwise direction in FIG. 2. As a result of the rotation of the square hole wheel 118, the spiral spring 122 housed in the barrel wheel 120 is wound up. Due to the force of the spiral spring 122, the barrel wheel 120 is constantly rotated in the same direction, namely, in a clockwise direction in FIG. 2.

If the rotating spindle 160 is rotated in a second direction, namely, in an anticlockwise direction in FIG. 2, the first transmission wheel 182 is rotated by the rotation of the rotating spindle teeth 178 in a clockwise direction in FIG. 2. In the same way as in the above described operation in which the rotating spindle 160 is rotated in the first direction, in the pawl lever 180, the eccentric shaft portion 182d makes an eccentric movement due to the rotation of the first transmission wheel 182. As a result of the eccentric movement of the pawl lever 180, the draw pawl 180c and the push pawl 180d each make a reciprocal movement along an outer circumferential portion of the second transmission wheel 184. As a result of this, due to the reciprocal movement of the draw pawl 180c and the push pawl 180d, the second transmission wheel 184 is rotated in a constant direction, namely, in an anticlockwise direction in FIG. 2. As a result of the rotation of the second transmission gear 184, the square hole wheel 118 is rotated in a constant direction, namely, in a clockwise direction in FIG. 2, and the spiral spring 122 housed in the barrel wheel 120 is wound up. Due to the rotation of the barrel wheel 120 there are rotations of the second wheel 124, the third wheel 126, the fourth wheel 128, the date rear wheel 148, and the cylindrical wheel 154. The rotation speed of the barrel wheel 120 is controlled by a speed adjustment apparatus that includes the adjuster 136 and by an escapement apparatus that includes the anchor 138 and the escapement wheel 134.

Next, a description will be given with reference made to Table 1 and Table 2 of an example of experimental data that shows that a resin containing carbon filler has excellent slide properties in the above described embodiments.

Table 1 shows the side properties (i.e., a coefficient of dynamic friction and a comparative abrasion quantity) of a polycarbonate resin (PC) and a polyamide resin 12 that contains 20 percent by weight of carbon filler (PA12). Namely, in Table 1, VGCF (registered trademark—Vapor Grown Carbon Fiber) is a resin to which 20 percent by weight of carbon filler has been added. As a result of this experimental data, it can be seen whether or not the surface of the resin containing the carbon fiber is very slidable and is very resistant to abrasion. Note that, in order to make a comparison, characteristics of a non-composite material (i.e., a resin simple substance, namely, the PA12 or PC by itself) to which carbon filler has not been added are shown as “BLANK”.

Each of the above resins was injection molded under molding conditions such as those shown in Table 2. Namely, for a composite material obtained by adding 20 percent by weight of carbon filler to PA12, the temperatures of the nozzle, front portion (i.e., the metering portion), the center portion (i.e., the compressed portion), the rear portion (i.e., the supply portion), and the molding die were set respectively to 220° C., 230° C., 220° C., 210° C., and 70° C. For the PA12 non-composite material, the respective temperatures were 190° C., 200° C., 180° C., 170° C., and 70° C. Furthermore, for a composite material obtained by adding 20 percent by weight of carbon filler to PC, each of the above temperatures were set respectively to 290° C., 310° C., 290° C., 270° C., and 80° C., while for the PC non-composite material, the respective temperatures were 280° C., 290° C., 270° C., 260° C., and 80° C.

In Table 1, the coefficients of dynamic friction and comparative abrasion quantities (mm³/N·km) show values when resin pieces having a predetermined shape (i.e., φ55 mm×a thickness of 2 mm) were slid along a steel plate (S45C) at a speed of 0.5 m/sec while a surface pressure of 50 N was applied thereto. Note that these measurement methods are in accordance with sliding wear test methods for plastic (see JIS K 7218 (wherein JIS=Japanese Industrial Standard)).

As is shown in Table 1, in the case of PA12 and PC, each of the slide performances (i.e., coefficients of dynamic friction and comparative abrasion quantities) is greatly improved for a composite material to which carbon filler has been added over a non-composite material to which nothing has been added. Here, the coefficient of dynamic friction is a standard of the surface smoothness and surface nature of these composite materials, and, for example, by forming the retainer and the like of a ball bearing from a composite material having a small coefficient of dynamic friction, it is possible to increase the slide characteristics of that ball bearing without having to use a lubricant. Moreover, by forming the retainer of a ball bearing from a composite material having a small comparative abrasion quantity, it is possible to increase the abrasion resistance of that retainer.

Therefore, in the present embodiments, because the components that constitute the retainers of the ball bearings are formed from a resin containing carbon filler, the slide properties of these retainers are improved, and it is possible to reduce the wear on the retainer even if a lubricant is not injected onto the balls in the ball bearing. Accordingly, according to the present embodiments, because there is no need to inject lubricant into the ball bearing, the performance of the ball bearing can be maintained over an extended period of time. Furthermore, it is possible to provide a ball bearing whose bearing characteristics such as dynamic torque and response are not easily affected by the temperature environment in which it is used.

In addition, according to the present embodiments, it is possible to achieve a ball bearing that can withstand heavier loads than a conventional ball bearing by injecting lubricant onto the balls of the ball bearing. Moreover, according to the present embodiments, because wear on the retainer is decreased, it is possible to restrict dust from being contained in the ball bearing lubricant, to suppress changes in the viscosity of the lubricant, and to provide a ball bearing that can withstand heavier loads and has a long lifespan.

As a result of the above, when the ball bearings of the present embodiments are used in a self-winding timepiece, a lengthening of the lifespan of the self-winding timepiece can be achieved.

### INDUSTRIAL APPLICABILITY

In the ball bearing of the present invention, the retainer is formed from a filler impregnated resin that is obtained by taking a thermoplastic resin as a base resin, and adding a carbon filler to this base resin. This filler impregnated resin has a low coefficient of friction and excellent abrasion characteristics. In the ball bearing of the present invention, because there is little possibility of the retainer becoming worn if lubricant oil is injected onto the balls, it is possible to decrease the possibility that abrasion powder will be contained in the lubricant oil. Accordingly, in the ball bearing of the present invention, there is little possibility of the viscosity of the lubricant oil changing, and there is thus little possibility that the performance of the ball bearing will deteriorate. Accordingly, in the ball bearing of the present invention, when lubricant oil is injected onto the balls, a structure can be achieved that is able to withstand heavy loads, and the lifespan of the ball bearing can be lengthened.

As a result of these effects, the ball bearing of the present invention can be widely used as a bearing in timepieces and measuring instruments; photographic, sound recording and image recording instruments; printing instruments; production, processing and assembling machinery; and transporting, conveyance and dispensing machinery and the like.

In the self-winding timepiece of the present invention, when lubricant oil is injected onto the balls, a structure can be achieved that is able to withstand heavy loads, and the lifespan of the self-winding timepiece can be lengthened. In addition, in the self-winding timepiece of the present invention, the above described problems associated with the injection can be avoided if lubricant oil is not injected onto the balls. Accordingly, in the self-winding timepiece of the present invention, if lubricant oil is not injected onto the balls, it is possible to achieve a structure that is able to withstand light loads, and an improvement in the performance of a timepiece can be achieved.

TABLE 1

| | | PA12 | | PC | |
|---|---|---|---|---|---|
| | | VGCF | | VGCF | |
| ITEMS | UNIT | 20 wt % | BLANK | 20 wt % | BLANK |
| COEFFICIENT OF | — | 0.25 | 0.56 | 0.18 | 0.51 |
| DYNAMIC FRICTION | | | | | |
| COMPARATIVE | mm³/N · km | 3.8 × 10⁻¹³ | 5.2 × 10⁻¹¹ | 3.3 × 10⁻⁸ | 8.1 × 10⁻⁸ |
| ABRASION QUANTITY | | | | | |

TABLE 2

| | PA12 | | PC | |
|---|---|---|---|---|
| | VGCF | BLANK | VGCF | BLANK |
| NOZZLE | 220° C. | 190° C. | 290° C. | 280° C. |
| FRONT | 230° C. | 200° C. | 310° C. | 290° C. |
| CENTER PORTION | 220° C. | 180° C. | 290° C. | 270° C. |
| REAR PORTION | 210° C. | 170° C. | 270° C. | 260° C. |
| TEMP. OF | 70° C. | 70° C. | 80° C. | 80° C. |
| MOLDING DIE | | | | |

1. A ball bearing comprising:
an outer side ring;
an inner side ring;
a plurality of balls; and
a retainer that positions the plurality of balls,
wherein
the outer side ring comprises outer side guide portions that guide the plurality of balls, and the inner side ring comprises inner side guide portions that guide the plurality of balls, and the plurality of balls are placed between the outer side guide portions and the inner side guide portions,
the retainer is formed from a filler impregnated resin, wherein
the filler impregnated resin comprises a base resin that is a thermoplastic resin,
the base resin is filled with a carbon filler, and
the carbon filler is made from carbon fiber as a filler, and
the carbon filler is selected from a group made up of mixtures obtained by doping boron in any one of a monolayer carbon nanotube, a multilayer carbon nanotube, a vapor grown carbon fiber, a nanografiber, a carbon nanophone, a cupstack type of carbon nanotube, a monolayer fullerene, a multilayer fullerene, and the aforementioned carbon filler.

2. The ball bearing according to claim 1, wherein the base resin is selected from a group that includes polystyrene, polyethylene terephthalate, polycarbonate, polyacetal(polyoxymethylene), polyamide, modified polyphenylene ether, polybutylene terephthalate, polyphenylene sulfide, polyether ether ketone, and polyetherimide.

3. The ball bearing according to claim 1, wherein
the inner side ring comprises an inner ring and an inner holding ring, and
the inner side guide portions are formed from the inner ring and the inner holding ring.

4. The ball bearing according to claim 1, wherein
the outer side ring comprises an outer ring and an outer holding ring, and
the outer side guide portions are formed from the outer ring and the outer holding ring.

5. The ball bearing according to claim 1, wherein
the retainer is formed into a circular cylinder shape and comprises guide holes or guide window portions that guide the plurality of balls, and
the guide holes or the guide window portions are formed to be separated each other on the retainer.

6. The ball bearing according to claim 1, wherein
the retainer is formed into a circular cylinder shape and comprises guide holes or guide window portions that guide the plurality of balls,
the guide holes or the guide window portions are formed to be separated each other on the retainer, and
the retainer further comprises an inward flange portion, wherein
the inward flange portion is formed to extend inwardly to a radial direction on the retainer, and
the inward flange portion comprises an inner side portion that is placed between the inner ring and the inner holding ring.

7. The ball bearing according to claim 1, wherein
the retainer is formed into a circular cylinder shape and the retainer comprises guide holes or guide window portions that guide the plurality of balls, wherein the guide holes or the guide window portions are formed to be separated each other on the retainer, and
the retainer further comprises an outward flange portion that is formed to extend outwardly to a radial direction on the retainer, wherein the outward flange portion comprises an outer side portion that is placed between the outer ring and the outer holding ring.

8. The ball bearing according to claim 1, wherein
the retainer comprises an upper retainer portion, that is formed into a circular cylinder shape, and a lower retainer portion, that is formed into a circular cylinder shape, wherein
the upper retainer portion and the lower retainer portion are constructed so as to be able to be attached to and separated from each other, and
the upper retainer portion and the lower retainer portion comprise guide window portions that guide the plurality of balls, wherein the guide window portions are formed to be separated each other on the upper retainer portion and the lower retainer portion.

9. A self-winding timepiece comprising:
a rotating spindle that comprises a rotation weight;
the ball bearing according to any one of claims 1 that supports the rotating spindle with rotatability;
a spiral spring ; and
a self-winding mechanism that is operated by a rotation of the rotating spindle in order to wind up the spiral spring.
